(19) United States
(12) Patent Application Publication
(10) Pub. No.: US 2012/0296695 A1
(43) Pub. Date: Nov. 22, 2012

(54) Risk Portal Including Index Tool

(75) Inventors: Steve McGill, Chicago, IL (US); Stephen Cross, Dublin (IE); Theresa Bourdon, Fulton, MD (US); Charles Michael Joiner, JR., Atlanta, GA (US); Hans H. van Heukelum, Elmhurst, IL (US)

(73) Assignee: Aon Global Risk Research Limited, Hamilton (BM)

(21) Appl. No.: 13/284,628

(22) Filed: Oct. 28, 2011

Related U.S. Application Data
(60) Provisional application No. 61/488,131, filed on May 19, 2011.
(60) Provisional application No. 61/488,126, filed on May 19, 2011.

(51) Int. Cl. G06Q 10/00

(52) U.S. Cl. 705/7.28

(57) ABSTRACT

Risk information portal systems and methods are provided. The portal allows business managers and others to track, organize and review risks. One or more social media news feeds may provide risk information that is found from social media sources. The portal may also provide research tools and interactive tools to locate industry pricing information. A risk maturity index tool also allows users to obtain a risk maturity score.

The present application claims priority to U.S. provisional patent application No. 61/488,131, filed on May 19, 2011 and entitled Global Risk Insight Platform for Insurance Brokers and to U.S. provisional patent application No. 61/488,126, filed on May 19, 2011 and entitled Statistical Analysis Platform for Predicting Insurance Carriers Most Likely to Accept a Particular Type of Client Risk. The entire disclosures of both applications are hereby incorporated by reference.

### FIELD OF THE INVENTION

This invention relates generally to systems and methods for managing business and risk information. More particularly, aspects of the invention provide methods and systems for generating a portal that provides business entities with risk management information and tools.

### DESCRIPTION OF RELATED ART

Business entities face a large number of risks that can impact business performance and even existence. Exemplary risks include those relating to natural disasters, supply chains, legal disputes, workforce issues such as compensation, benefits, retirement, hiring, development, etc, manufacturing, reputation of brands and products and labor. It can be difficult for business managers and others to appreciate all of the risks relevant to a business entity.

Prior attempts to organize and track risks have included generating multiple reports and review multiple sources of information. It can be difficult for business managers and others to access multiple sources and digest large amounts of information.

Therefore, there is a need in the art for improved systems and methods for tracking, scoring, organizing and presenting risks.

### BRIEF SUMMARY OF THE INVENTION

Aspects of the invention overcome problems and limitations of the prior art by providing portal systems and methods that allow business managers and others to track, organize, review and manage risk related information. In embodiment, social media sources are analyzed and one or more news feeds are displayed on the portal. Other embodiments include providing interactive pricing and research tools. In one particular embodiment, users may answer a series of questions to obtain a risk maturity score.

Additional or alternative embodiments may be partially or wholly implemented on a computer-readable medium, for example, by storing computer-executable instructions or modules, or by utilizing computer readable data structures.

Of course, the methods and systems of the above-referenced embodiments may also include other additional elements, steps, computer-executable instructions or computer-readable data structures. In this regard, other embodiments are disclosed and claimed herein as well.

The details of these and other embodiments of the present invention are set forth in the accompanying drawings and the description below. Other features and advantages of the invention will be apparent from the description and drawings and from the claims.

### BRIEF DESCRIPTION OF THE DRAWINGS

The present invention is illustrated by way of example and not limited in the accompanying figures in which like reference numerals indicate similar elements and in which:

FIG. 1 shows an exemplary prior art computer system and network that may be used to implement aspects of the invention.

FIG. 2 illustrates an exemplary portal screenshot that includes risk data in accordance with an embodiment of the invention.

FIG. 3 illustrates an exemplary process that may be used to provide pricing and risk information to users, in accordance with an embodiment of the invention.

FIG. 4 illustrates a structure of questions that may be used to generate a risk maturity index in accordance with an embodiment of the invention.

FIG. 5 illustrates a scoring scheme for generating a risk maturity index in accordance with an embodiment of the invention.

FIG. 6 illustrates a method of generating a risk maturity index for a business entity at a computer device, in accordance with an embodiment of the invention.

FIG. 7 illustrates a process that may be performed by a computer device to generate results from a search of social media sources, in accordance with an embodiment of the invention.

### DETAILED DESCRIPTION

Various embodiments of the invention may be implemented with computer devices, computer networks and systems that exchange and present information.

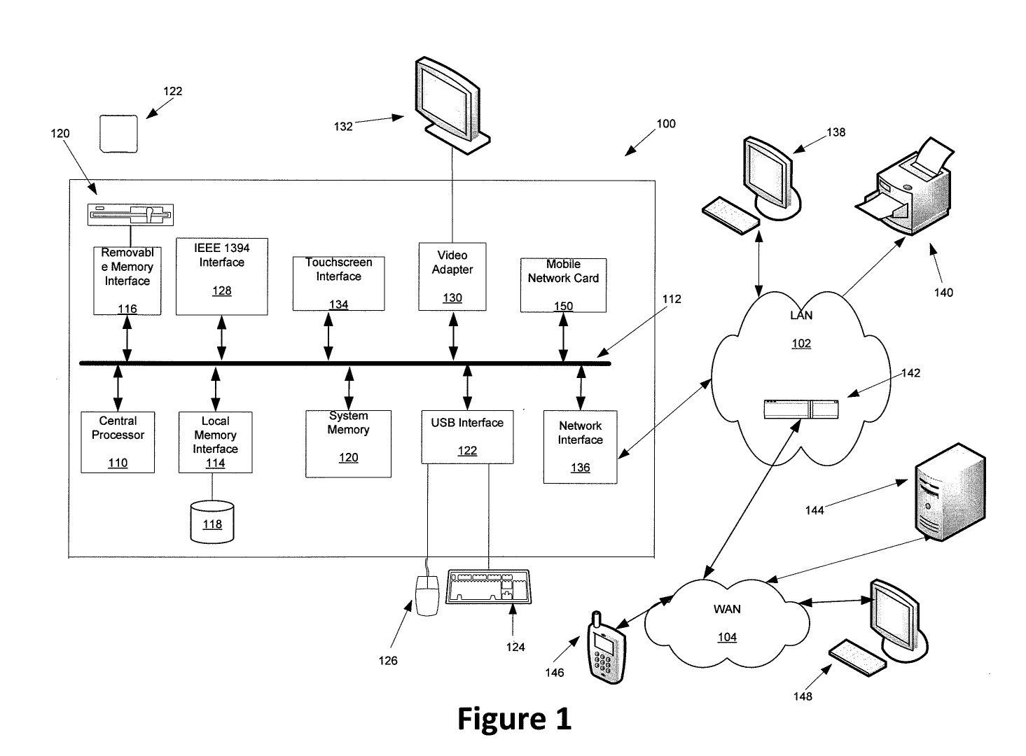

Elements of an exemplary computer system are illustrated in FIG. 1, in which the computer 100 is connected to a local area network (LAN) 102 and a wide area network (WAN) 104. Computer 100 includes a central processor 110 that controls the overall operation of the computer and a system bus 112 that connects central processor 110 to the components described below. System bus 112 may be implemented with any one of a variety of conventional bus architectures.

Computer 100 can include a variety of interface units and drives for reading and writing data or files. In particular, computer 100 includes a local memory interface 114 and a removable memory interface 116 respectively coupling a hard disk drive 118 and a removable memory drive 120 to system bus 112. Examples of removable memory drives include magnetic disk drives and optical disk drives that receive removable memory elements 122. Hard disks generally include one or more read/write heads that convert bits to magnetic pulses when writing to a computer-readable medium and magnetic pulses to bits when reading data from the computer readable medium. A single hard disk drive 118 and a single removable memory drive 120 are shown for illustration purposes only and with the understanding that computer 100 may include several of such drives. Furthermore, computer 100 may include drives for interfacing with other types of computer readable media such as magneto-optical drives.

Unlike hard disks, system memories, such as system memory 120, generally read and write data electronically and do not include read/write heads. System memory 120 may be implemented with a conventional system memory having a read only memory section that stores a basic input/output system (BIOS) and a random access memory (RAM) that stores other data and files.

A user can interact with computer 100 with a variety of input devices. FIG. 1 shows a universal serial bus (USB) interface 122 coupling a keyboard 124 and a pointing device 126 to system bus 112. Pointing device 132 may be implemented with a hard-wired or wireless mouse, track ball, pen device, or similar device.

Computer 100 may include additional interfaces for connecting peripheral devices to system bus 112. FIG. 1 shows a IEEE 1394 interface 128 that may be used to couple additional devices to computer 100. Peripheral devices may include game pads scanners, printers, and other input and output devices and may be coupled to system bus 112 through parallel ports, game ports, PCI boards or any other interface used to couple peripheral devices to a computer.

Computer 100 also includes a video adapter 130 coupling a display device 132 to system bus 112. Display device 132 may include a cathode ray tube (CRT), liquid crystal display (LCD), field emission display (FED), plasma display or any other device that produces an image that is viewable by the user. A touchscreen interface 134 may be included to couple a touchscreen (not shown) to system buss 112. A touchscreen may overlay at least part of the display region of display device 132 and may be implemented with a convention touchscreen technology, such as capacitive or resistive touchscreen technology.

One skilled in the art will appreciate that the device connections shown in FIG. 1 are for illustration purposes only and that several of the peripheral devices could be coupled to system bus 112 via alternative interfaces. For example, a video camera could be connected to IEEE 1394 interface 128 and pointing device 126 could be connected to another interface.

Computer 100 may include a network interface 136 that couples system bus 112 to LAN 102. LAN 102 may have one or more of the well-known LAN topologies and may use a variety of different protocols, such as Ethernet. Computer 100 may communicate with other computers and devices connected to LAN 102, such as computer 138 and printer 140. Computers and other devices may be connected to LAN 102 via twisted pair wires, coaxial cable, fiber optics or other media. Alternatively, electromagnetic waves, such as radio frequency waves, may be used to connect one or more computers or devices to LAN 102.

A wide area network 104, such as the Internet, can also be accessed by computer 100. FIG. 1 shows network interface 136 connected to LAN 102. LAN 102 may be used to connect to WAN 104. FIG. 1 shows a router 142 that may connect LAN 102 to WAN 104 in a conventional manner. A server 144. Mobile terminal 146 and a computer device 148 are shown connected to WAN 104. Of course, numerous additional servers, computers, handheld devices, personal digital assistants, telephones and other devices may also be connected to WAN 104.

In some embodiments, a mobile network card 150 may be used to connect to LAN 102 and/or WAN 104. Mobile network card may be configured to connect to LAN 102 and/or WAN 104 via a mobile telephone network in a conventional manner.

The operation of computer 100 and server 144 may be controlled by computer-executable instructions stored on a computer-readable medium. For example, computer 100 may include computer-executable instructions for transmitting information to server 144, receiving information from server 144 and displaying the received information on display device 132. Furthermore, server 144 may include computer-executable instructions for, receiving requests from computer 100, processing data and transmitting data to computer 100. In some embodiments server 144 transmits hypertext markup language (HTML) and extensible markup language (XML) formatted data to computer 100.

As noted above, the term “network” as used herein and depicted in the drawings should be broadly interpreted to include not only systems in which remote storage devices are coupled together via one or more communication paths, but also stand-alone devices that may be coupled, from time to time, to such systems that have storage capability. Consequently, the term “network” includes not only a “physical network” 102 and 104, but also a “content network,” which is comprised of the data—attributable to a single entity—which resides across all physical networks.

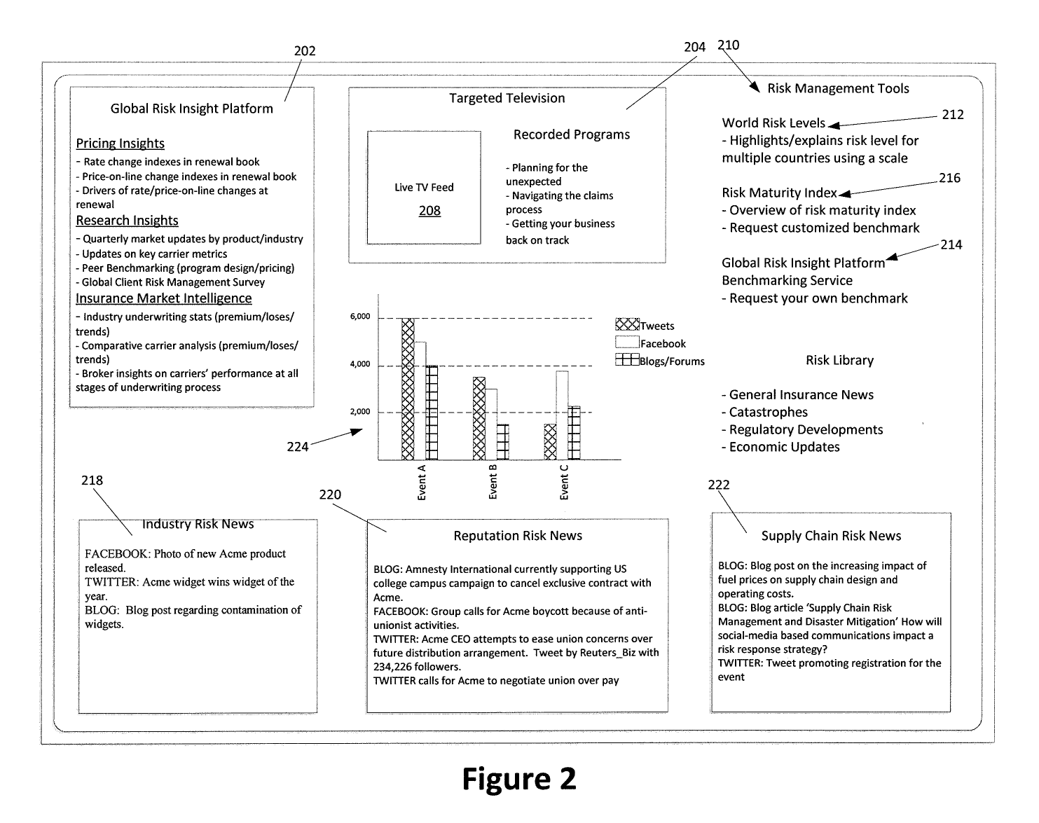

In various embodiments of the invention, one or more computer devices are used to generate a risk portal that allows business entities to view and interact with a wide range of risk data. As used herein, business entities is not limited to for profit entities and includes government entities and nonprofit entities. FIG. 2 illustrates an exemplary portal screenshot 200 that includes risk data in accordance with an embodiment of the invention. The data used to populate screenshot 200 may be transmitted from a computer device, such as server 144 (shown in FIG. 1). Server 144 and/or other computer devices may generate a plurality of portals that each contain risk data relevant to a particular business entity.

Portal screenshot 200 is divided into several sections. A global risk insight platform section 202 may be included to allow a business entity to access information such as pricing insights, research insights and insurance market insights. In some embodiments, the data used to populate global risk insight platform 202 may originate with Aon's Global Risk Insight Platform (GRIP). Aon's Global Risk Insight Platform includes a database of insurance placement data, delivering critical marketplace intelligence. The platform provides insight across carriers, industries and products on every level, from individual transactions to global trends. The platform also enables benchmarking of like risks placed throughout the globe, and at what price, in order to help clients evaluate insurer performance and anticipate shifts in the market.

A global risk insight platform's function may be to collate and process historical and aggregated information crucial to the insurance policy decisions specific to buyers and sellers separately by class and geography around the globe. The information provided includes various business performance analytics that do not include individual trade pricing data. The data is presented in a user-friendly format that indicates in general terms the extent and approximate value of coverage which carriers are quoting and binding in particular classes and territories. Sophisticated algorithms allow a reinsurer to predict insurance buying behavior in the coming months, thereby informing strategic marketing and buying decisions, and enabling its clients to stay ahead of the market.

Brokers and other entities may only be able to view global risk insight platform data specific to their country, region, state or other category used to identify a subset of data. Carriers are also able to obtain accumulated information on classes of business and territories in which they are interested. This benchmarking exercise allows carriers to assess in general terms how they are performing relative to their peers, which enables them to improve their products and services, and to make them more attractive to potential clients. Moreover, the platform provides insight into market conditions across multiple geographies. As such, access to global risk insight platform technology will provide an indirect benefit of forging a more coherent marketplace, by facilitating cross-border coverage.

Both sides of the market also benefit from an ‘introduction’ function, which brings together clients whose insurance policies are due for renewal and those carriers that have the risk appetites for that client's custom, typically in competition with the incumbent insurer. Clients benefit because the introduction of additional carriers increases competition among carriers for client business. The introduction function is another example of a reinsurer utilizing through a global risk insight platform the wealth of prior transaction data that it has at its disposal. The traditional means of brokering introductions between clients and carriers at renewal time was somewhat haphazard and reliant entirely on the knowledge possessed by individual brokers. A global risk insight platform may introduce a sophisticated and systematic introduction service which allows proactive matching of client needs to carrier risk appetite and which, in turn, allows all parties to deploy their resources more efficiently and objectively. It also enables a reinsurer to better understand the market as a whole and thereby to obtain the best terms and conditions for its clients, as a reinsurer continues to open its client renewal portfolio to all carriers, irrespective of whether they procure solutions offered by a global risk insight platform.

A global risk insight platform system may create an increased degree of transparency in insurance markets, which on the one hand alerts brokers and their clients to market conditions worldwide, while on the other encourages carriers to offer clients increasingly differentiated offerings. In seeking to create this “virtuous circle,” the platform ensures that the global risk insight platform simultaneously protects from disclosure any confidential information that has the potential to facilitate collusion in the market.

The benchmarking service offered by a global risk insight platform may be one of the elements that provides the power to support brokers' instincts with facts and statistics across all major insurance markets.

In some embodiments, global risk insight platform trading data may be collected at three key points during the process of placing an insurance policy: first, when a reinsurer informs carriers about a client policy opportunity (known as a “trade” or a “submission”); second, when the chosen carriers provide their response to a policy proposal (“quote” or “decline”); and third, when the client decides which carrier option it wants to accept (a “hit”, a “win” or a “bind”). Opinion data is collected by way of responses to questionnaires. The information is collected by brokers and directly inputted by them into a global risk insight platform database at the time of collection.

In one embodiment, a global risk insight platform service may provide two services: (1) the information provided to brokers for use with their clients; and (2) the information provided to carriers procuring global risk insight platform services. Both elements rely on the same underlying data, but each provides different levels of insight, presented in different ways. This differentiation is designed both to satisfy the commercial drivers of the different sides of the market and the desire to be competition law compliant. For example, carriers that access a global risk insight platform can access only individually tailored information screen, known as a “carrier dashboard.” By contrast, brokers, on behalf of their clients, can only access specifically selected information available through the “broker dashboard.” Each broker has a specialist dashboard, which is tailored to his own area of expertise.

A global risk insight platform allows brokers to identify the carrier and policy structure that best suits each of its individual client's needs with far more accuracy than is generally available in the broking industry previously. Because the input of global risk insight platform data occurs at both the quotation stage as well as at the bind stage, the global risk insight platform can see the shape of markets as they emerge. Brokers can predict the likely movement of markets with much greater precision, across a variety of product lines, than was possible prior to its introduction.

A global risk insight platform may also introduce much more efficiency into the brokering process. Reinsurers can use a global risk insight platform to analyze by industry, segment, product and region, a carrier's record in converting trades into quotes and quotes into binds, thereby having a more precise view of those carriers with the strongest risk appetite for their clients. It can also look at factors such as retentions and limits, and begin to discern the different risk appetites of carriers for a particular product, based on a carrier's prior trading behavior and clients' own buying habits. This allows brokers to target submissions towards a range of carriers who are likely to have an appetite for a particular risk.

Because a global risk insight platform technology can provide information on market conditions in a variety of countries, it can promote cross-border and even cross region trading where this is in the interest of a particular client. Because a global risk insight platform has a complete data set for trades which pass through its channels, it can show, for example, whether it might be more beneficial for a client to place a particular policy in Paris or in Amsterdam, assuming the carrier is willing to write a risk across EU borders.

Another use of a global risk insight platform tool is the introduction service which it facilitates, through which carriers are given insight into when clients' existing insurance contracts are coming up for renewal. This effectively enables a reinsurer to institute on behalf of its clients an informal tender process for business which might not otherwise have been subject to much competition. This creation of greater visibility has the potential to invite greater interest in a client's customs and therefore more options for clients, whereas that client might otherwise have been tempted simply to renew its policy with the incumbent carrier. The introduction tool facilitates a systematic approach to understanding the options available to a client matching their needs with carrier deliverables. It also greatly improves carriers' ability to deploy their limited resources in the most effective way to meet client needs.

Again, however, the transparency created through the use of a global risk insight platform technology also inures to the benefit of carriers, insofar as the type of information to which they have access allows them to put together more robust, competitive service offerings. It is not the sort of transparency whose effect, nor whose intention, is to diminish the availability of competitive options. Instead, insurers can expect that with better information with which to communicate, brokers will be more up-to-date with the carrier's risk appetite and their value proposition, and will have a better understanding in general of clients' requirements and needs and their operating performance in relation to their peers. This will make interactions more efficient and effective allowing brokers to better provide value to clients and carriers and allow both reinsurers and carriers to serve the needs of their mutual clients in a better and faster manner.

All data available to carriers on a global risk insight platform may be retrospective. Prior to being made available to carriers, the data may undergo a rigorous “cleansing” to ensure that data made available meets established standards. Data may also be processed by a processing entity, first to identify and correct anomalies, and then to perform the necessary analytics. The data undergoes this process for a period usually around 45 days, prior to being released into the global risk insight platform system on a quarterly basis. Upon its release, it is mingled into a data pool made up of significantly older data points, themselves anonymised and aggregated. This pooling process is designed to ensure that there can be no possible facilitation of any collusive practices, whether in theory or in practice, through the introduction of the data introduced quarterly.

In various embodiments, a global risk insight platform may provide hit rate, market flow, conversion rate, declination rate, broker insights, pipeline, statistics and other types of information to users.

Hit rate represents the proportion of quotes issued by a carrier which ultimately result in the provision of binding policies. As with quote rate, this information is particularly useful to brokers using a global risk insight platform broker dashboard or portal to assess the likelihood that a particular carrier will be accepted by a client. For each phase, a dashboard or portal may track the market as a whole, and also allows a carrier to compare itself against the aggregate average performance of its anonymous top five competitors.

Market flow information may be available to carriers utilizing a global risk insight platform. Information may be presented on an annualized basis and is updated quarterly, through the process of mixing more recent information with existing older, anonymized, aggregated data. Again, it may be presented on a percentage basis, against the total book of business for a particular product, client industry and region. Users can also split the information to show incumbent against non-incumbent carriers.

Conversion rate represents the proportion of trades which ultimately result in binding quotes. It may be calculated by multiplying submission rates by quote rates and then by hit rates. As with submission rates, knowledge of conversion rates can allow a carrier to focus on particular industries and products in which it has an appetite for risk, and to greatly improve its service offering.

A global risk insight platform carrier dashboard or portal may provide overviews from both the carrier and client perspective on the reasons why insurance proposals have been declined. This information is input by the broker at the time that either the carrier or the client declines a quote, and is selected from one of twenty standardized declination reasons. The carrier may then be presented with the top five reasons for declination (as a percentage of the total reasons for declination), and split further according to the carrier's preferences by reference to product, industry and deal size. The declination rationale data tool is clearly performance enhancing, as it enables carriers to determine key areas in which their performance can be improved.

A broker insights screen may be provided to present clients with key customer opinion data. It may be based on the established Net Promoter Score (“NPS”) customer loyalty metric. At its root, an NPS rating is obtained by asking customers, on a “0 to 10” rating scale, how likely they would be to recommend a product to a friend or colleague. Based on their responses, customers are categorized into one of three groups: Promoters (9-10 rating), Passives (7-8 rating), and Detractors (0-6 rating). The percentage of Detractors is then subtracted from the percentage of Promoters to obtain a Net Promoter Score. Under the NPS system, companies are encouraged to supplement this question with further queries, thereby soliciting the reasons for a customer's rating of that company or product. These reasons can then be provided to front-line employees and management teams for follow-up action.

A global risk insight platform dashboard or portal may provide two elements in a pipeline opportunity monitoring section. The first is a statistical analysis of a reinsurer's renewal book of business, while the second is a report of upcoming policy renewal opportunities. A pipeline statistical analysis tool may show for each selected geographic area the total number and total value of renewal possibilities on a reinsurer's book of business falling due in the next six months. Carriers can view this information by product or by industry. This tool assists carriers in planning their future business. Brokers do not have access to the carrier dashboard.

A pipeline report tool may list opportunities arising from existing policies that are brokered which are due for renewal in the near term. The information available in this case includes client name, industry, product, approximate deal size, region, and month of maturity.

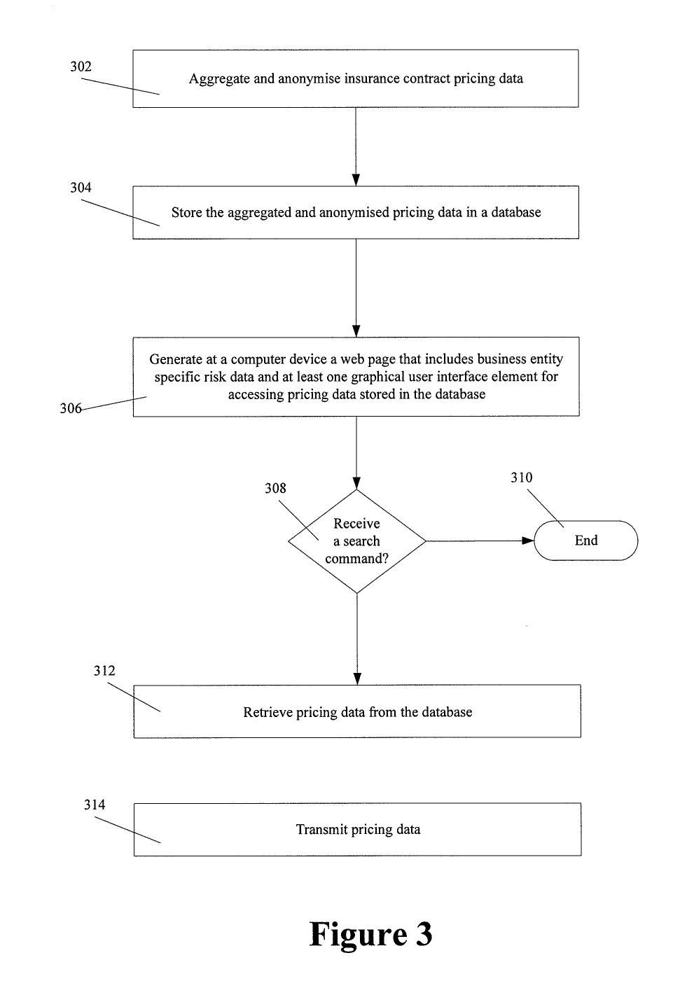

FIG. 3 illustrates an exemplary process that may be used to provide pricing and risk information to users, in accordance with an embodiment of the invention. The process shown in FIG. 3 may be performed by a server or other computer device connected to a network. First, in step 302, insurance pricing data is aggregated and anonymised. Insurance pricing data may be confidential. Aggregating and anonymising data helps to keep prevent associating data with a particular source. In step 304, the aggregated and anonymised pricing data is stored in a database. In some embodiments data may be aged before being stored in a database to make it more difficult to associate the data with a particular source. Pricing data may include real time pricing data, data used in contract proposals, data used in finalized contracts or data used in contract proposals and data used in finalized contracts.

A server computer or other computer device may next generate a webpage that includes business entity specific risk data and at least one graphical user interface element for accessing pricing data stored in the database in step 306. The webpage may include some or all of the features shown in FIG. 2. Step 306 may include providing an HMTL listing for generating a portal webpage. In step 308, a computer device determines whether a search command has been received. The search command may be received as the result of a user selecting one of more graphical user interface elements displayed on a webpage portal. When no command is received, the process ends in step 310. As those skilled in the art will appreciate, FIG. 3 illustrates only a portion of a process that may be executed by a server or other computer. While the segment shown in FIG. 3 may end in step 310, other processes may begin or be repeated.

When a search command has been received, in step 310 pricing data is retrieved from the database. Step 310 may include executing one or more search routines or templates. Finally, after the pricing data is retrieved, the pricing data may be transmitted in step 314. Step 314 may include transmitting pricing data from a server computer to another computer device. The pricing data may be displayed on a portal webpage.

Portal screenshot 200 may also include a video section 204. Video section 204 may include links to recorded programs 206 that may be general in nature and/or targeted toward specific business entities. For example, a recorded program may relate to mitigating reputation risk concerns for a particular business entity. Video section 204 may also include a live TV feed section 208. Live TV feed section 208 may be used to provide real time information to business entities. For example, during a hurricane live TV feed section 208 may include an expert explaining how current hurricane developments may impact a business entity.

A risk management tools section 210 may be included to provide users with a variety of risk management tools. A worldwide risk levels link 212 may be selected to display a map that illustrates and explains risk levels around the world or within a specific geographic region. The map may be color coded to represent overall risks to supply chains, manufacturing capabilities, reputation and other elements. A Global insight platform benchmarking service link 214 may be selected to request a benchmark.

Risk management tools section 210 may also include a risk maturity index section. The risk maturity index section may include a link to provide an overview of a risk maturity index. In one embodiment, a risk maturity index is created from answers to a questionnaire on risk management processes, corporate governance and risk understanding.

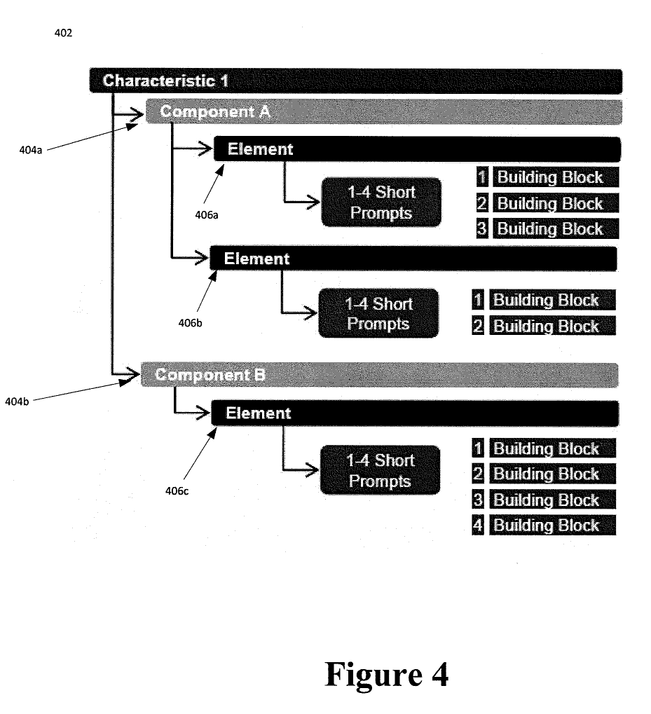

FIG. 4 illustrates a structure of questions that may be used to generate a risk maturity index in accordance with an embodiment of the invention. At a first level, questions are classified according to characteristics of risk management best practices 402. Exemplary characteristics include board-level understanding of and commitment to risk management as a critical factor for decision making and for driving value, transparency of risk communication, a risk culture that encourages full engagement and accountability at all levels of the organization, participation of key stakeholders in risk management strategy development and policy setting and use of sophisticated quantification methods to understand risk and demonstrate added value through risk management.

Within each characteristic, questions may be classified at a second level according to components 402a and 404b. For example, under a “board-level understanding of and commitment to risk management as a critical factor for decision making and for driving value” characteristic, components may include the content of board reporting and frequency of board reporting. At a third level, elements 406a, 406b and 406c may include the actual questions and response options. For example, an element under frequency of board reporting may include answers corresponding to reporting periods. The components and elements may be “building blocks” or activities that would exemplify and organization's level of development along a given characteristic.

In exemplary embodiments, questions that may be used to generate a risk maturity index include questions relating to one or more of: (1) corporate governance, (2) risk identification and evaluation processes, (3) risk culture and communications, and (4) risks and decision making.

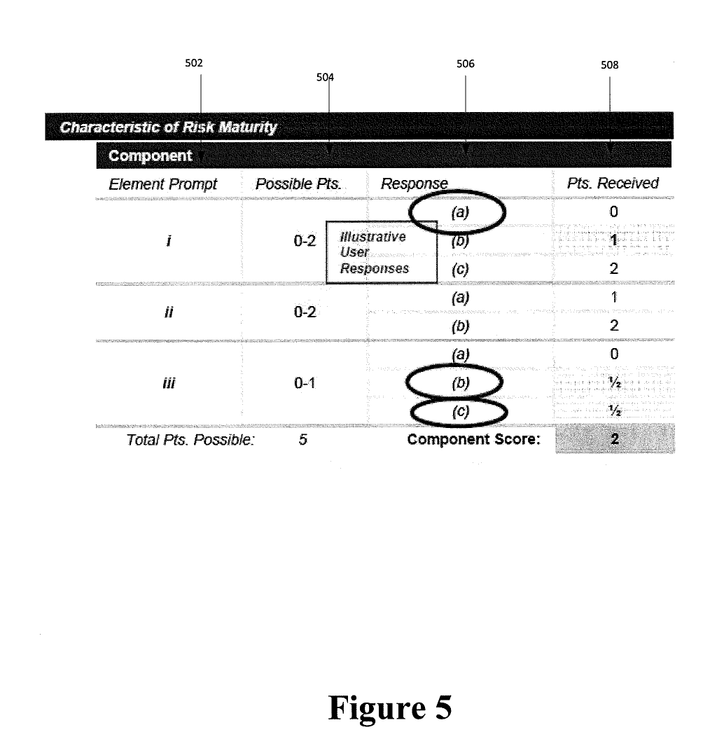

FIG. 5 illustrates a scoring scheme for generating a risk maturity index in accordance with an embodiment of the invention. A first column 502 lists the element prompts or questions for each component. A second column 504 lists the possible points for each element prompt or question. As shown in FIG. 5, element prompts or questions may have different values. In some embodiments the total points possible for each component is the same. The points possible may also be the same for every characteristic. Utilizing a common scale makes the index easy to use and allows users to compare scores at different levels of granularity. For example, an overall index score may have a range of 1-9 (with ability to score at 0.5 intervals), each characteristic score may also have a range of 1-9 and each component score may have a range of 1-9. Column 506 lists user responses and column 508 lists points received.

In one exemplary scoring scheme, the risk maturity index has a scale of 1-5. A score of 5 is “advanced” and indicates that the organization has a well developed ability to identify, measure, manage and monitor risks; risk management processes are dynamic and adapt to changing risks and business cycles. A score of 4 is “operational” and indicates that there is a clear understanding of the organization's key risks and also a consistent execution of activities to address these risks; some functional areas may employ more sophisticated techniques. A score of 3 is “defined” and indicates that the organization understands and is addressing its key risks and capabilities to measure, manage and monitor risks are in place but may be inconsistent across the organization. A score of 2 is “basic” and indicates that there is inconsistent understanding, management and monitoring of key risks across the organization and that capabilities to consistently identify, assess, manage and monitor risks are limited. A score of 1 is “initial” and indicates that when the organization identifies and addresses risks it is done within silos only and components and activities of the risk management process are limited in scope and implemented in an ad-hoc manner.

In various embodiments when reporting score, products and services that may be utilized to increase scores may also be provided.

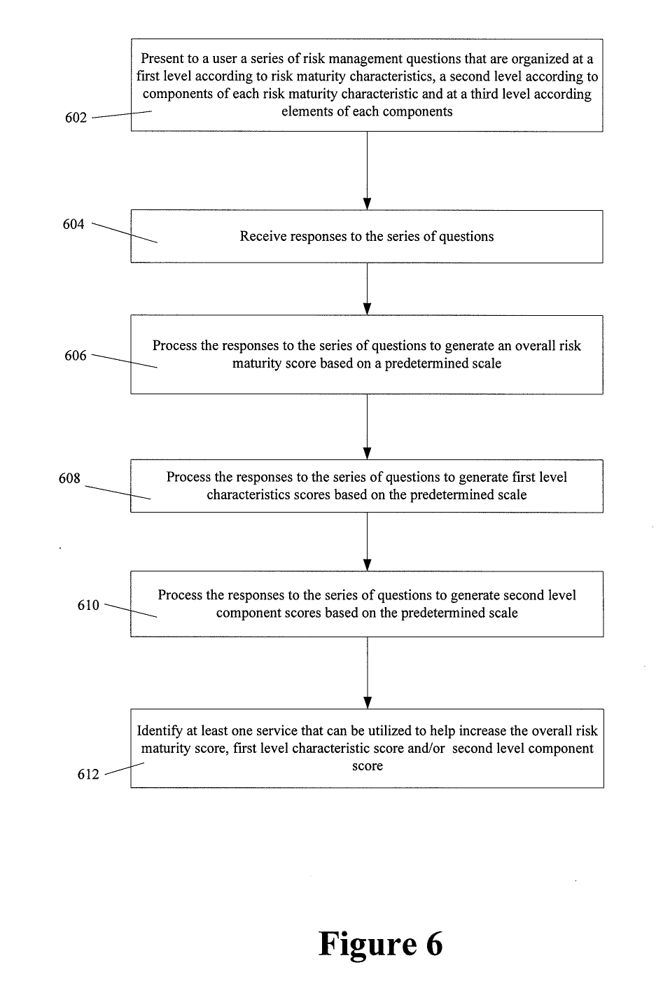

FIG. 6 illustrates a method of generating a risk maturity index for a business entity at a computer device, in accordance with an embodiment of the invention. First, in step 602 a series of risk management questions are presented to a user. The risk management questions are organized at a first level according to risk maturity characteristics, a second level according to components of each risk maturity characteristic and at a third level according elements of each components. Next, in step 604 a server or other computer device receives responses to the series of questions. The responses may be processed at a computer device to generate an overall risk maturity score based on a predetermined scale in step 606. In step 608 the responses to the series of questions are processed at the computer device to generate first level characteristics scores based on the predetermined scale. In step 610 the responses to the series of questions are processed at the computer device to generate first second characteristics scores based on the predetermined scale. In some embodiments steps 606, 608 and 610 may be combined and may use the scoring scheme shown in FIG. 5. Finally, in step 612 at least one product or service may be identify that can be utilized to help increase at least one second level component score.

Returning to FIG. 2, portal screenshot 200 may also risk information derived from one or more social media sources, such as blogs, Twitter and Facebook. Social media sources may show trends that are not reported by other sources of information. For example, a Facebook group may be attempting to convince users to boycott a product and this event may not be reported by traditional news sources. Social media sources may also report news sooner than other traditional news sources.

Social media sources may be monitored to provide industry risk news in an industry risk news section 218, reputation risk news in a reputation risk news section 220 and supply chain risk news in a supply chain risk news section 222. In some embodiments, business entities provide search criteria, search templates or other information used to located relevant social media posts. In various embodiments, social media information may be filtered with one or more computer devices, manually or with a combination of computer devices and manual filtering. Each section may include a news feed that identifies the social media source and provides a brief summary of the content. The news feed may be in the form of a hyperlink that allows user to link to the source of the content. In some embodiments, users may select the social media sources that will be monitored. Users may also provide specific areas to monitor and may provide search criteria. For example, a user may decided to delete industry risk news and substitute industry risk news section 218 with a risk section relating to a newly released product. The user may provide search criteria for the newly released product.

Portal screenshot 200 may also include a graph section 224 that illustrates counts of mentions of the news events by a plurality of social media sources over a predetermined time period. Graph section 224 shows relative numbers of mentions by a plurality of social media sources for three events, Event A, Event B and Event C. One skilled in the art will appreciate that the events may include natural disasters, company boycotts or any other types of events that represent risks to business entities.

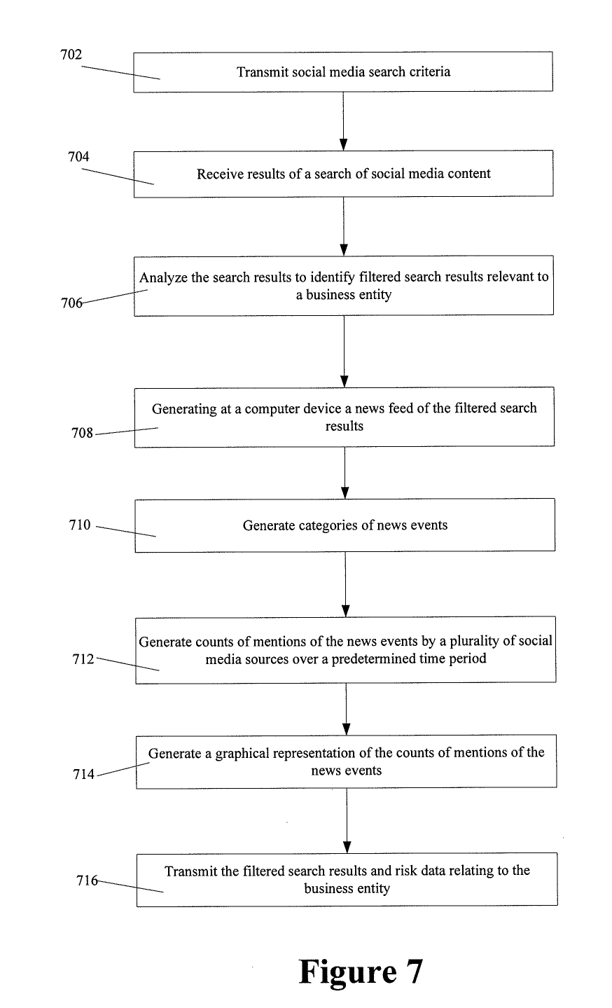

FIG. 7 illustrates a process that may be performed by a computer device to generate results from a search of social media sources, in accordance with an embodiment of the invention. First, in step 702, social media search criteria is transmitted. Step 702 may include transmitting search criteria from a server operated by one entity to anther entity that will perform the search. In an alternative embodiment step 702 may include receiving search criteria from a user of the portal. The search criteria may include the identification of a business entity, supply chain information, brand information and/or other information that can be used to filter social media content. A search of social media may be performed manually, at a server that hosts a risk portal or at one or more other computer devices.

In step 704 results of the search of social media are received. The search results may be further analyzed to identify filtered search results relevant to a business entity in step 706. In embodiments that utilize and automated process, steps 704 and 706 may be combined. In some embodiments step 304 may be performed by a computer device and step 706 may be performed by one of more humans analyzing the search results.

A server or other computer device may create a news feed of filtered search results in step 708. Step 708 may include generating one or more RSS feeds that will be used to populate a portal screen, such as the one shown in FIG. 2. In other embodiments a news feed may include data marked up with a mark up language such as XML.

In step 710 categories of news events may be generated. The categories may be limited to a specific number, such as three categories having the highest number of mentions. Next, in step 712, counts of mentions of the news events by a plurality of social media sources over a predetermined time period may be generated. The counts may be used to generate a graphical representation of the counts of mentions of the news events in step 714. The graphical representation may be similar to the graph shown in graph section 224 in FIG. 2. Finally, in step 716, the filtered search results and risk data relating to the business entity may be transmitted. Step 716 may include transmitting data to a computer device that displays a risk portal. Those skilled in the art will appreciate that the steps shown in FIG. 7 are merely exemplary and additional or alternative steps may be included to generate data that will be displayed on a risk portal, such as the one illustrated in FIG. 2.

The present invention has been described herein with reference to specific exemplary embodiments thereof. It will be apparent to those skilled in the art that a person understanding this invention may conceive of changes or other embodiments or variations, which utilize the principles of this invention without departing from the broader spirit and scope of the invention as set forth in the appended claims. All are considered within the sphere, spirit, and scope of the invention.

We claim:

1. A method of generating a risk maturity index for a business entity, the method comprising:
(a) receiving responses to a series of questions that are organized at a first level according to risk maturity characteristics, a second level according to components of each risk maturity characteristic and at a third level according elements of each components;
(b) at a computer device processing the responses to the series of questions to generate an overall risk maturity score based on a predetermined scale; and
(c) at the computer device processing the responses to the series of questions to generate first level characteristics scores based on the predetermined scale.

2. The method of claim 1, wherein the predetermined scale has 9 levels.

3. The method of claim 1, further including:
(d) at the computer device processing the responses to the series of questions to generate second level component scores based on the predetermined scale.

4. The method of claim 1, further including:
(e) at the computer device identifying at least one service that can be utilized to help increase the overall risk maturity score.

5. The method of claim 4, further including:
(f) at the computer device identifying at least one service that can be utilized to help increase at least one first level characteristic score.

6. The method of claim 5, further including:
(g) at the computer device identifying at least one service that can be utilized to help increase at least one second level component score.

7. The method of claim 1, further including generating a comparison of the overall risk maturity score it scores of industry peers.

8. The method of claim 1, wherein the series of questions include questions relating to board of director level understanding of risk management.

9. The method of claim 1, wherein the series of questions include questions relating transparency of risk communications.

10. The method of claim 1, wherein the series of questions include questions relating to participation of stakeholders in risk management strategy development and policy setting.

11. A method of providing risk information, the method comprising:
(a) generating a news feed of social media content relevant to a business entity;
(b) receiving responses to a series of questions that are organized at a first level according to risk maturity characteristics, a second level according to components of each risk maturity characteristic and at a third level according elements of each components;
(c) at a computer device processing the responses to the series of questions to generate an overall risk maturity score based on a predetermined scale;
(d) at the computer device processing the responses to the series of questions to generate first level characteristics scores based on the predetermined scale; and
(e) transmitting from a computer device the overall risk maturity score, the first level characteristics scores and the news feed.

12. The method of claim 11, further including inserting hyperlinks to social media sources into the news feed.

13. The method of claim 11, further including:
(i) generating categories of news events;
(ii) generating counts of mentions of the news events by a plurality of social media sources over a predetermined time period; and
(iii) generating at a computer device a graphical representation of the counts of mentions of the news events.

14. The method of claim 13, wherein the graphical representation comprises a bar graph.

15. The method of claim 13, further including transmitting the graphical representation of the counts of mentions of the news events.

16. The method of claim 11, further including compiling industry risk news relating to a business entity and transmitting the industry risk news.

17. The method of claim 11, further including compiling reputation risk news relating to a business entity and transmitting the reputation risk news.

18. The method of claim 1, further including compiling supply chain risk news relating to a business entity and transmitting the supply chain risk news.

19. A non-transitory computer-readable medium containing computer-executable instructions that when executed cause a computer device to perform the steps comprising:
(a) generating a news feed of social media content relevant to a business entity;
(b) receiving responses to a series of questions that are organized at a first level according to risk maturity characteristics, a second level according to components of each risk maturity characteristic and at a third level according elements of each components;
(c) processing the responses to the series of questions to generate an overall risk maturity score based on a predetermined scale;
(d) processing the responses to the series of questions to generate first level characteristics scores based on the predetermined scale; and
(e) transmitting the overall risk maturity score, the first level characteristics scores and the news feed.

20. The non-transitory computer-readable medium of claim 19, further including computer executable instructions that when executed cause a computer device to perform the steps comprising:
(f) inserting hyperlinks to social media sources into the news feed.
